(19) United States
(12) Patent Application Publication
(10) Pub. No.: US 2015/0329694 A1
(43) Pub. Date: Nov. 19, 2015

(54) POLYLACTIC ACID RESIN COMPOSITION AND MOLDED BODY WHICH IS OBTAINED USING SAME

(71) Applicant: UNITIKA LTD., Hyogo (JP)

(72) Inventors: Nariaki Ishii, Kyoto (JP); Yutaka Taketani, Kyoto (JP); Kazuko Inoue, Kyoto (JP); Yusuke Okita, Kyoto (JP); Azusa Usui, Kyoto (JP); Kazue Ueda, Kyoto (JP); Ken-ichi Kawada, Kyoto (JP)

(73) Assignee: UNITIKA LTD., Hyogo (JP)

(21) Appl. No.: 14/409,107

(22) PCT Filed: Jul. 19, 2013
(86) PCT No.: PCT/JP2013/069590

§ 371 Date: Dec. 18, 2014

(30) Foreign Application Priority Data
Jul. 2, 2012 (JP) 2012-161614
Nov. 14, 2012 (JP) 2012-250305

(51) Int. Cl. C08K 3/22; C08L 69/00; C08L 67/04

(52) U.S. Cl. CPC C08K 3/22; C08L 67/04; C08L 69/00; C08K 2003/2231; C08L 2205/24; C08L 2207/53; C08L 2205/06

(57) ABSTRACT

The polylactic acid resin composition of the present invention includes a polylactic acid resin (A) having a D-isomer content of 0 to 2.0 mol % or 98.0 to 100 mol %. The polylactic acid resin composition of the present invention further includes tin oxide (B) in an amount of 0.005 to 10 parts by mass in relation to 100 parts by mass of the polylactic acid resin (A). By using the polylactic acid resin composition of the present invention, a molded body being excellent in crystallinity and heat resistance, and at the same time, having sufficiently excellent moisture-heat durability can be obtained.

### TECHNICAL FIELD

The present invention relates to a polylactic acid resin composition and a molded body which is obtained by using the polylactic acid resin composition.

### BACKGROUND ART

In general, as the resin material for molding, for example, the following resins are used: polypropylene resin (PP), acrylonitrile-butadiene-styrene resin (ABS), polyamide resin (such as PA6 or PA66), polyester resin (such as PET or PBT) and polycarbonate resin (PC). The molded products produced from such resins are excellent in moldability and mechanical strength. However, when such molded products are discarded, the amount of the waste is correspondingly increased and additionally the discarded molded products are little decomposed in the natural environment; hence even when the discarded molded products are subjected to underground burying disposal, the discarded molded products semi-eternally remain underground.

Accordingly, nowadays, from the viewpoint of environmental preservation, biodegradable polyester resins are attracting attention. Above all, for example, polylactic acid, polyethylene succinate and polybutylene succinate can be mass-produced and hence are low in cost and high in usefulness. Polylactic acid has already been made to be industrially producible by using as raw materials plants such as corn and sweet potato. Moreover, even when incinerated after use, in view of the carbon dioxide absorbed when these plants grow, the balance between the emission and absorption of carbon can be made nearly vanishing. On the basis of these factors, polylactic acid is particularly low in the load against the global environment.

By allowing the crystallization of polylactic acid to sufficiently proceed, the heat resistance of polylactic acid is improved, and polylactic acid can be made applicable to wide applications. However, the crystallization rate of polylactic acid alone is extremely slow.

Accordingly, for the purpose of improving the crystallization rate, Patent Literature 1 has proposed the addition of a carboxylic acid amide or ester having a specific molecular structure. Patent Literature 2 has proposed the addition of ethylene-bis-12-hydroxystearic acid amide.

For the purpose of making polylactic acid resin applicable in wide applications, in particular, in the field of industrial materials, Patent Literature 3 and Patent Literature 4 have proposed the improvement of the moisture-heat durability of polylactic acid resin by using a carbodiimide compound and various additives.

Moreover, Patent Literature 5 has proposed the addition of a specific amount of polyisocyanate and a specific amount of conductive metal oxide particles to a polylactic acid in which the molar ratio between the L-isomer and the D-isomer is 95/5 to 64/40 or 40/60 to 5/95, for the purpose of obtaining an expandable resin composition excellent in productivity while the biodegradability of the expandable resin composition is being maintained.

### CITATION LIST

### Patent Literature

Patent Literature 1: International Publication No. WO 2006/137397

Patent Literature 2: Japanese Patent Laid-Open No. 2003-226801

Patent Literature 3: Japanese Patent Laid-Open No. 2006-249152

Patent Literature 4: Japanese Patent Laid-Open No. 2009-209233

Patent Literature 5: Japanese Patent Laid-Open No. 2000-086802

### SUMMARY OF INVENTION

### Technical Problem

However, the techniques of Patent Literature 1 to Patent Literature 5 do not allow the crystallization to proceed sufficiently, and do not allow heat resistance of the obtained molded bodies to be sufficiently improved.

There has never been proposed a polylactic acid resin which allows the crystallisation rate to be fast, the crystallization to proceed sufficiently, and thus a molded body excellent in heat resistance to be obtained, and at the same time, is excellent in moisture-heat durability and can also be used in the field of industrial materials.

The present invention solves the above-described problems, and an object of the present invention is to provide a polylactic acid resin composition excellent in crystallinity (fast in crystallization rate, and allowing crystallization to proceed easily) and capable of obtaining a molded body excellent in heat resistance, and sufficiently excellent in moisture-heat durability, and a molded body which is obtained by using the resin composition.

### Solution to Problem

The present inventors performed a continuous diligent study for the purpose of solving the above-described problems, and consequently, have reached the present invention. Specifically, the gist of the present invention is as follows.

(1) A polylactic acid resin composition including a polylactic acid resin (A) having a D-isomer content of 0 to 2.0 mol % or 98.0 to 100 mol % and tin oxide (B), wherein the tin oxide (B) is included in an amount of 0.005 to 10 parts by mass in relation to 100 parts by mass of the polylactic acid resin (A).

(2) The polylactic acid resin composition according to (1), wherein the D-isomer content in the polylactic acid resin (A) is 0 to 0.6 mol % or 99.4 to 100 mol %.

(3) The polylactic acid resin composition according to (1), further including an impact resistance improver (C), wherein the impact resistance improver (C) is contained in an amount of 0.5 to 15 parts by mass in relation to 100 parts by mass of the polylactic acid resin (A).

(4) The polylactic acid resin composition according to (1), including a thermoplastic resin (M) other than the polylactic acid resin (A), wherein the mass ratio (A/M) of the polylactic acid resin (A) to the thermoplastic resin (M) is 20/80 to 80/20.

(5) A molded body obtained by molding the polylactic acid resin composition according to (1).

### Advantageous Effects of Invention

The polylactic acid resin composition of the present invention uses the polylactic acid resin (A) having the D-isomer content falling within in a specific range, and is excellent in crystallinity. In other words, the polylactic acid resin composition of the present invention is fast in crystallization rate, and additionally, allows the crystallization to proceed sufficiently easily. Accordingly, the use of the polylactic acid resin composition allows a molded body excellent in heat resistance to be obtained. The inclusion of a specific amount of the tin oxide (B) in the polylactic acid resin (A) like this improves the moisture-heat durability as well as crystallinity, without impairing the voidability. Accordingly, the polylactic acid resin composition of the present invention allows a molded body excellent in heat resistance and moisture-heat durability, without impairing the exterior appearance of the molded body. Consequently, the range of use of polylactic acid resin, which is a low environmental load material, can be widened largely, and the industrial utility value of polylactic acid resin can be increased.

Additionally, the molded body obtained by using the polylactic acid resin composition of the present invention is usable in various applications such as applications in the fields of vehicle components, in the electric and electronic fields, and in the fields of daily commodities and industrial materials.

### DESCRIPTION OF EMBODIMENTS

Hereinafter, the present invention is described in detail. In the first place, in the polylactic acid resin (A) constituting the polylactic acid resin composition of the present invention, the D-isomer content is required to be 0 to 2.0 mol % or 98.0 to 100 mol %. The D-isomer content failing in this range D allows the polylactic acid resin composition of the present invention to foe excellent in crystallinity. In other words, the crystallisation rate is fast, and additionally, the crystallisation tends to sufficiently proceed, and hence a molded body excellent in heat resistance can be obtained. The inclusion of the tin oxide (B), described below, also allows the polylactic acid resin composition to be excellent in crystallinity. The moisture-heat durability is an effect to be improved mainly by including the below-described tin oxide (B); however, the use of the polylactic acid resin (A) having the D-isomer content falling within this range further allows the moisture-heat durability to be improved. When the D-isomer content falls outside the above-described range, it is difficult to sufficiently improve both crystallinity and moisture-heat durability even with the inclusion of the tin oxide (B).

From the viewpoint of crystallinity and moisture-heat durability, the D-isomer content in the polylactic acid resin (A) is preferably, above all, 0 to 1.0 mol % or 99.0 to 100 mol %, and more preferably 0 to 0.6 mol % or 99.4 to 100 mol %.

In the present invention, the D-isomer content in the polylactic acid resin (A) means the proportion (mol %) of the D-lactic acid unit in the whole lactic acid units constituting the polylactic acid resin (A). Accordingly, for example, in the case of a polylactic acid resin (A) having a D-isomer content of 1.0 mol %, the proportion of the D-lactic acid unit is 1.0 mol % and the proportion of the L-lactic acid unit is 99.0 mol %, in the polylactic acid resin (A).

In the present invention, as below described in Examples, the D-isomer content in the polylactic acid resin (A) is calculated by using a method in which the L-lactic acid and the D-lactic acid obtained by decomposing the polylactic acid resin (A) are all methyl esterified, and the methyl ester of the L-lactic acid and the methyl ester of the D-lactic acid are analyzed with a gas chromatographic analyzer.

In view of the molding processability of the resin composition of the present invention, the melt flow rate (measured at 190° C., under a load of 21.2 N) of the polylactic acid resin (A) is preferably 0.1 to 50 g/10 min and more preferably 0.2 to 40 g/10 min. When the melt flow rate is 50 g/10 min or less, an appropriate melt viscosity is obtained, and a molded body having satisfactory mechanical properties and heat resistance is obtained. When the melt flow rate is 0.1 g/10 min or more, the load at the time of molding processing can be sufficiently reduced, and satisfactory operability can be obtained.

As the polylactic acid resin (A) used in the present invention, among various commercially available polylactic acid resins, the polylactic acid resins having a D-isomer content falling within the range specified in the present invention can be used. As the polylactic acid resin (A) used in the present invention, a polylactic acid can be used which is produced by using, among the lactides, which are cyclic dimers or lactic acid, a L-lactide having a sufficiently low D-isomer content or a D-lactide having a sufficiently low L-isomer content, and by adopting a heretofore known melt polymerization method or a melt polymerization method in combination with a solid-phase polymerization method.

Into the polylactic acid resin (A) of the present invention, a cross-linked structure may also be introduced. The method for introducing a cross-linked structure is not particularly limited; however, it is preferable to use a method in which a (meth)acrylic acid ester compound and a peroxide are mixed in the polylactic acid resin (A).

Next, the tin oxide (B) is described. Examples of the tin oxide (B) used in the present invention include SnO (stannous oxide), SnO₂ (stannic oxide) and SnO₃. Among these, it is preferable to use SnO₂ because of being relatively easily available. The tin oxide (B) may be either in a crystalline state or in an amorphous state. The inclusion of the tin oxide (B) in the polylactic acid resin (A) having the D-isomer content falling within the specific range allows the crystallinity and the moisture-heat durability of the polylactic acid resin (A) to be improved.

The content of the tin oxide (B) is required to be 0.005 to 10 parts by mass, is preferably 0.01 to 5 parts by mass, more preferably 0.02 to 3 parts by mass and particularly preferably 0.1 to 3 parts by mass, in relation to 100 parts by mass of the polylactic acid resin (A). When the content of the tin oxide (B) is less than 0.005 part by mass, it is difficult to improve the crystallinity and the moisture-heat durability of the polylactic acid resin (A). On the other hand, when the content of the tin oxide (B) exceeds 10 parts by mass, the specific gravity of the resin composition is increased, thus the application of the resin composition is restricted, and the quality of the obtained molded body is made poor, for example, in such a way that the surface of the obtained molded body has a feeling of roughness.

The average particle size of the tin oxide (B) is preferably 1 μm to 10 μm and more preferably 2 μm to 5 μm, in view of the dispersibility in the polylactic acid resin (A), and the improvement effects of the crystallinity and the moisture-heat durability. When the average particle size of the tin oxide (B) is less than 1 μm, the tin oxide (B) tends to absorb moisture, and hence the polylactic acid resin tends to be decomposed. With such an average particle size, the tin oxide (B) tends to be aggregated to degrade the dispersibility thereof. When the average particle size of the tin oxide (B) exceeds 10 μm, the surface area, of the tin oxide (B) becomes smaller, and the aforementioned improvement effects of the crystallinity and the moisture-heat durability become poor.

It is preferable to use the tin oxide (B) as particles formed only of tin oxide. Alternatively, composite particles may also be used which are prepared by covering with tin oxide the surface of the particles formed of a metal oxide other than tin oxide, a metal or a polymer. Composite particles may also he used which are prepared by doping an element such as indium or antimony in the particles made of the tin oxide (B). Even when such tin oxide (B) is used, the content of only tin oxide is required to satisfy the above-described range.

Examples of the method for measuring the content of the tin oxide (B) in the polylactic acid resin composition of the present invention include: a method in which the amount of tin in a resin composition is measured by inductively coupled plasma (ICP) measurement; a method in which a resin composition is dissolved in a solvent or the like to remove the resin and the residual inorganic component is subjected to X-ray analysis; and a method in which the content of the tin oxide (B) is measured with an Auger microprobe.

The polylactic acid resin composition of the present invention preferably further includes an impact resistance improver (C). In the present invention, the use of the impact resistance improver (C) along with the tin oxide (B) remarkably improves the impact resistance.

The impact resistance improver (C) is preferably at least one of a core-shell graft copolymer and a (meth)acrylic acid ester polymer.

The core-shell graft copolymer has a structure called a so-called core-shell type structure constituted with a core layer and a shell layer covering the corer layer, wherein the adjacent layers are constituted with different types of polymers. The core layer and the shell layer may each be constituted with one layer, or a plurality of layers, namely, two or more layers. The core-shell graft copolymer is preferably a copolymer obtained by graft polymerizing the shell component in the presence of the core component.

From the viewpoint of the improvement of impact resistance, the core component forming the core layer is preferably a rubber component. The rubber component is more preferably at least one selected from the group consisting of a butadiene rubber, an acrylic rubber, a silicone rubber and a silicone-acrylic rubber.

Examples of the butadiene rubber include a polymer obtained by polymerizing only the 1,3-butadiene monomer, and a polymer obtained by polymerizing the 1,3-butadiene monomer and one or more types of vinyl monomers copolymerizable with the 1,3-butadiene monomer.

Of the monomers constituting the butadiene rubber, the proportion of the aforementioned vinyl monomer is preferably 50% by mass or less and more preferably 30% by mass or less.

Examples of the vinyl monomer copolymerizable with 1,3-butadiene include: aromatic vinyl compounds such as styrene and α-methylstyrene; methacrylic acid alkyl esters such as methyl methacrylate and ethyl methacrylate; acrylic acid alkyl esters such as ethyl acrylate and n-butyl acrylate; unsaturated nitriles such as acrylonitrile and methacrylonitrile; vinyl ethers such as methyl vinyl ether and butyl vinyl ether; vinyl halides such as vinyl chloride and vinyl bromide; vinylidene halides such as vinylidene chloride and vinylidene bromide; and glycidyl group-containing vinyl monomers such as glycidyl acrylate, glycidyl methacrylate, allyl glycidyl ether and ethylene glycol glycidyl ether.

Examples of the acrylic rubber include: a polymer obtained by polymerizing only an acrylic acid ester monomer; and a polymer obtained by polymerizing an acrylic acid ester monomer and a vinyl monomer copolymerizable with the acrylic acid ester monomer.

Of the monomers constituting the acrylic rubber, the proportion of the acrylic acid ester is preferably 50 to 100% by mass and more preferably 70 to 100% by mass. Of the monomers constituting the acrylic rubber, the proportion of the vinyl monomer copolymerizable with the acrylic acid ester is preferably 50% by mass or less and more preferably 30% by mass or less.

Examples of the acrylic acid ester include the acrylic acid alkyl esters in each of which the alkyl group has 2 to 8 carbon atoms. Examples of the acrylic acid alkyl ester in which the alkyl group has 2 to 8 carbon atoms include ethyl acrylate, n-butyl acrylate and 2-ethylhexyl acrylate.

Examples of the vinyl monomer copolymerizable with the acrylic acid ester include: aromatic vinyls such as styrene and α-methylstyrene; methacrylic acid alkyl esters such as methyl methacrylate and ethyl methacrylate; unsaturated nitriles such as acrylonitrile and methacrylonitrile; vinyl ethers such as methyl vinyl ether and butyl vinyl ether; vinyl halides such as vinyl chloride and vinyl bromide; vinylidene halides such as vinylidene chloride and vinylidene bromide; and glycidyl group-containing vinyl monomers such as glycidyl acrylate, glycidyl methacrylate, allyl glycidyl ether and ethylene glycol glycidyl ether.

Examples of the silicone rubber include a rubber containing a polyorganosiloxane which is a linear polymer having a few thousand of organosiloxane bond units.

Examples of the silicone-acrylic robber include a rubber including a polyorganosiloxane and an alkyl (meth)acrylate rubber.

The production method of the rubber is not particularly limited, but is preferably an emulsion polymerization method.

The shell component forming the shell layer is preferably the polymers of an unsaturated carboxylic acid alkyl ester monomer, a glycidyl group-containing vinyl monomer, an aliphatic vinyl monomer, an aromatic vinyl monomer, a vinyl cyanate monomer, a maleimide monomer, an unsaturated dicarboxylic acid monomer, an unsaturated dicarboxylic acid anhydride monomer and/or other vinyl monomers. Among these, the polymers of the unsaturated carboxylic acid alkyl ester monomer, the glycidyl group-containing vinyl monomer and/or the unsaturated dicarboxylic acid anhydride monomer are preferable, and the polymer of the unsaturated carboxylic acid alkyl ester monomer is more preferable.

The unsaturated carboxylic acid alkyl ester monomer is preferably a (meth)acrylic acid alkyl ester. Examples of such a (meth)acrylic acid alkyl ester include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, stearyl (meth)acrylate, octadecyl (meth)acrylate, phenyl (meth)acrylate, benzyl (meth) acrylate, chloromethyl (meth)acrylate, 2-chloroethyl (meth)acrylate, 2-hydroxyethyl (meth)acrylate, 3-hydroxypropyl (meth)acrylate, 2,3,4,5,6-pentahydroxyhexyl (meth)acrylate, 2,3,4,5-tetrahydroxypentyl (meth)acrylate, aminoethyl acrylate, propylaminoethyl acrylate, dimethylaminoethyl methacrylate, ethylaminopropyl methacrylate, phenylaminoethyl methacrylate and cyclohexylaminoethyl methacrylate. From the viewpoint of the dispersibility in the resin, methyl (meth)acrylate and n-butyl (meth)acrylate are preferable among these.

Examples of the glycidyl group-containing vinyl monomer include glycidyl (meth)acrylate, glycidyl itaconate, diglycidyl itaconate, allyl glycidyl ether, styrene-4-glycidyl ether and 4-glycidylstyrene. Because of improving the impact resistance, glycidyl (meth)acrylate is preferable among these.

Examples of the aliphatic vinyl monomer include ethylene, propylene and butadiene.

Examples of the aromatic vinyl monomer include styrene, α-methylstyrene, 1-vinylnaphthalene, 4-methylstyrene, 4-propylstyrene, 4-cyclohexylstyrene, 4-dodecylstyrene, 2-ethyl-4-benzylstyrene, 4-(phenylbutyl)styrene and halogenated styrenes.

Examples of the vinyl cyanate monomer include acrylonitrile, methacrylonitrile and ethacrylonitrile.

Examples of the maleimide monomer include maleimide, N-methylmaleimide, N-ethylmaleimide, N-propylmaleimide, N-isopropylmaleimide, N-cyclohexylmaleimide, N-phenylmaleimide, N-(p-bromophenyl) maleimide and N-(chlorophenyl)maleimide.

Examples of the unsaturated dicarboxylic acid monomer include maleic acid, monoethyl maleate, itaconic acid and phthalic acid.

Examples of other vinyl monomers include styrene, acrylamide, methacrylamide, N-methylacrylamide, butoxymethylacrylamide, N-propylmetharylamide, N-vinyldiethylamine, N-acetylvinylamine, allylamine, methallylamine, N-methylallylamine, p-aminostyrene, 2-isopropenyl-oxazoline, 2-vinyl-oxazoline, 2-acroyl-oxazoline and 2-stryl-oxazoline.

Among the core-shell graft copolymers, the core-shell graft copolymers of the following first to third preferable aspects remarkably provide the improvement effect of the impact resistance.

As the first preferable aspect of the core-shell graft copolymer, there is quoted a combination of an acrylic rubber as the core component with a polymer obtained by polymerizing a vinyl monomer as the shell component. The shell component is more preferably a methyl (meth)acrylate polymer. The core-shell graft copolymer is preferably obtained by graft polymerizing one or two or more vinyl monomers with the acrylic rubber in the presence of the acrylic, rubber. Examples of commercially available core-shell graft copolymers include “Paraloid BPM-500” and “Paraloid BPM-515” (trade names), manufactured by Rohm and Haas Corp., and “Metablen W-450A” and “Metablen W-600A” (trade names), manufactured by Mitsubishi Rayon Co., Ltd.

As the second preferable aspect of the core-shell graft copolymer, there is quoted a combination of a composite polymer, as the core component, having an acrylic rubber component and a silicone rubber component with a polymer, as the shell component, obtained by polymerizing a glycidyl group-containing vinyl monomer. The core component is preferably a composite polymer obtained by polymerizing an alkyl acrylate monomer and a polyether monomer having a silyl group at the terminal thereof, and more preferably an epoxy-modified silicone-acrylic rubber. Examples of commercially available epoxy-modified silicone-acrylic rubbers include “Metablen S-2200” (trade name), manufactured by Mitsubishi Rayon Co., Ltd.

As the third preferable aspect of the core-shell graft copolymer, there is quoted a combination of a butadiene rubber as the core component with a methyl methacrylate polymer as the shell component. The core component is more preferably a methyl methacrylate-butadiene rubber. Examples of commercially available methyl methacrylate-butadiene rubbers include “Metablen C-223” and “Metablen C-323A” (trade names), manufactured by Mitsubishi Rayon Co., Ltd., “Kane Ace B-564” (trade name), manufactured by Kaneka Corp., and “Paraloid BPM-520” (trade name), manufactured by Rohm and Haas Corp.

Examples of the monomer constituting the (meth)acrylic acid ester polymer used for the impact resistance improver include acrylic acid and the esters thereof, and methacrylic acid and the esters thereof. These monomers may be used each alone or as combinations of two or more thereof. Examples of the copolymers include block copolymers, random copolymers, graft copolymers and the combinations of these.

Specific examples of (meth)acrylic acid and the esters thereof include methyl (meth)acrylate, ethyl (meth) acrylate, propyl (meth)acrylate, isopropyl (meth) acrylate, n-butyl (meth)acrylate, isobutyl (meth)acrylate, s-butyl (meth)acrylate, t-butyl (meth)acrylate, neopentyl (meth)acrylate, ethylhexyl (meth)acrylate, isodecyl acrylate, lauryl (meth)acrylate, tridecyl (meth)acrylate, stearyl (meth)acrylate, benzyl (meth)acrylate, tetrahydrofurfuryl (meth)acrylate, methoxyethyl (meth)acrylate, dimethylaminoethyl (meth)acrylate, chloroethyl (meth)acrylate, trifluoroethyl (meth)acrylate, heptadecafluorooctylethyl (meth)acrylate, isobornyl (meth)acrylate, adamantyl (meth)acrylate and tricyclodecynyl (meth)acrylate. Additionally, styrene and monomers of substituted styrenes such as α-methylstyrene, t-butylstyrene and chlorostyrene may also be copolymerized.

The (meth)acrylic acid ester copolymers may be prepared by using heretofore known techniques.

As the first preferable aspect of the (meth)acrylic acid ester polymer, there is quoted an ultrahigh molecular weight (meth)acrylic acid ester polymer having a weight average molecular weight of 1,000,000 or more and 15,000,090 or less. The use of the ultrahigh molecular weight (meth)acrylic acid ester polymer having a weight average molecular weight falling in the above-described range remarkably improves the impact resistance and also improves the flexibility. When the weight average molecular weight is less than 1,000,000, no sufficient improvement effects of the impact resistance and the flexibility are obtained. On the other hand, when the weight average molecular weight exceeds 15,000,000, the compatibility of the obtained resin composition may be disadvantageously impaired, or the melt viscosity of the obtained resin composition may become disadvantageously excessively high so as to make it difficult to handle the resin composition.

The weight average molecular weight of such a (meth)acrylic acid ester polymer is more preferably 1,200,000 to 10,000,000 and furthermore preferably 1,500,000 to 7,000,000.

Examples of the commercially available products of the (meth)acrylic acid ester polymer of the first preferable aspect include: the Metablen P-Series manufactured by Mitsubishi Rayon Co., Ltd., the Paraloid K-Series manufactured by Rohm and Haas Corp. and the Kane Ace PA-series manufactured by Kaneka Corp.

As the second preferable aspect of the (meth)acrylic acid ester polymer, there is quoted a block copolymer (hereinafter, denoted as the block copolymer P) of methyl methacrylate and n-butyl acrylate. The use of the block copolymer P remarkably improves the impact resistance, and also improves the flexibility and the impact resistance against falling ball impact or failing weight impact.

Because the improvement effects of the flexibility and the impact resistance are sufficiently obtained, the proportion of n-butyl acrylate monomer in the monomers constituting the block copolymer P is preferably 60% by mass or more and more preferably 75% by mass or more.

The block copolymer P is preferably a block copolymer having a molecular chain constituted with hard blocks each formed of 1 to 5 methyl methacrylate units and soft blocks each formed of 1 to 5 n-butyl acrylate units.

The hard blocks formed of the methyl methacrylate units in the molecular chain of the block copolymer P contribute to the satisfactory compatibility with the polylactic acid resin (A) or the thermoplastic resin (M). The soft blocks formed of the n-butyl acrylate units in the molecular chain of the block copolymer P contribute to the improvement of the flexibility or the impact resistance.

Examples of the commercially available products of the block copolymer P of the second preferable aspect include “Kurarity LA2140e” (trade name, the content of n-butyl acrylate: 77% by mass), manufactured by Kuraray Co., Ltd. and “Kurarity LA2250” (trade name, the content of n-butyl acrylate: 67% by mass), manufactured by Kuraray Co., Ltd.

The content of the impact resistance improver (C) in the polylactic acid resin composition of the present invention is, in view of the effect to impart impact resistance to the resin composition, preferably 0.5 to 15 parts by mass, more preferably 1 to 12 parts by mass and particularly preferably 3 to 10 parts by mass, in relation to 100 parts by mass of the polylactic acid resin (A).

When the content of the impact resistance improver (C) is less than 0.5 part by mass, no sufficient impact resistance can be imparted to the resin composition. On the other hand, when the content of the impact resistance improver (C) exceeds 15 parts by mass, the improvement effect of the impact resistance reaches a saturated state, and the crystallinity of the resin composition is degraded.

In the polylactic acid resin composition of the present invention, the thermoplastic resin (M) other than the polylactic acid resin (A) may also be included, for the purpose of compensating for the various properties of the polylactic acid resin (A). Examples of the thermoplastic resin (M) include polyolefin, polyester, polyamide, polycarbonate (PC resin), polystyrene, polymethyl (meth)acrylate (PMMA resin), poly(acrylonitrile-butadiene-styrene) copolymer (ABS resin), liquid crystal polymer and polyacetal.

Examples of the polyolefin include polyethylene (PE resin) and polypropylene (PP resin). Examples of the polyamide include polyamide 6, polyamide 66, polyamide 610, polyamide 11, polyamide 12 and polyamide 6T. Examples of the polyester include a large number of polyesters including various aromatic polyesters and various aliphatic polyesters. Specific examples of the aromatic polyester include polyethylene terephthalate, polybutylene terephthalate, polyacylate and polybutylene adipate terephthalate. Specific examples of the aliphatic polyester include polybutylene succinate, poly(butylene succinate-lactic acid) copolymer and polyhydroxybutyric acid.

Examples of the other polyesters include polycyclohexylenedimethylene terephthalate, polyethylene naphthalate, polybutylene naphthalate, polyethylene isophthalate-co-phthalate, polybutylene isophthalate-co-terephthalate, polyethylene terephthalate/cyclohexylenedimethylene terephthalate, cyclohexylenedimethylene isophthalate-co-terephthalate, copolyester composed of p-hydroxybenzoic acid residue and ethylene terephthalate residue, and polytrimethylene terephthalate composed of 1,3-propanediol, which is a material derived from plants.

The method for allowing the thermoplastic resin (M) to be included in the polylactic acid resin composition is not particularly limited.

The mass ratio (A/M) of the polylactic acid resin (A) to the thermoplastic resin (M) is preferably 20/80 to 80/20 and more preferably 30/70 to 70/30.

When the mass ratio (A/M) falls within the above-described range, the properties of both of the polylactic acid resin (A) and the thermoplastic resin (M) are obtained in a well-balanced manner.

The polylactic acid resin composition of the present invention preferably further includes a carbodiimide compound. The addition of the carbodiimide compound to the polylactic acid resin is known to improve the moisture-heat durability; in the present invention, the use of the carbodiimide compound along with the polylactic acid resin (A) and the tin oxide (B) markedly improves the moisture-heat durability.

As the carbodiimide compound, various carbodiimide compounds can be used. Specific examples of the carbodiimide include N,N′-di-2,6-diisopropylphenylcarbodiimide, inside, N,N′-di-o-tolylcarbodiimide, N,N′-diphenylcarbodiimide, N,N′-dioctyldecylcarbodimide, N,N′-di-2,6-dimethylphenylcarbodiimide, N-tolyl-N′-cyclohexylcarbodiimide, N,N′-di-2,6-di-tert-butylphenylcarboodiimide, N-tolyl-N′-phenylcarbodiimide, N,N′-di-p-nitrophenylcarbodiimide, N,N′-di-p-aminophenylcarboodiimide, N,N′-di-p-hydroxyphenylcarbodiiimide, N,N′-di-cyclohexylcarbodiimide, N,N′-di-p-tolylcarbodiimide, p-phenylene-bis-di-o-tolylcarbodiimide, p-phenylene-bis-dicyclohexylcarbodiimide, hexamethylene-bis-dicyclohexylcarbodiimide, ethylene-bis-diphenylcarbodiimide, N,N′-benzylcarbodiimide, N-octadecyl-N′-phenylcarbodiimide, N-benzyl-N′-phenylcarbodiimide, N-octadecyl-N′-tolylcarbodiimide, N-cyclohexyl-N′-tolylcarbodiimide, N-phenyl-N′-tolylcarbodiimide, N-benzyl-N′- tolylcarbodiimide, N,N′-di-o-ethylphenylcarbodiimide, N,N′-di-p-ethylphenylcarbodiimide, N,N′-di-o-isopropylphenylcarbodiimide, N,N′-di-p-isopropylphenylcarbodiimide, N,N′-di-o-isobutylphenylcarbodiimide, N,N′-di-p-isobutylphenylcarbodiimide, N,N′-di-2,6-diethylphenylcarbodiimide, N,N′-di-2-ethyl-6-isopropylphenlylcarbodiimide, N,N′-di-2-isobutyl-6-isopropylphenylcarbodiimide, N,N′-di-2,4,6-trimethylphenylcarbodiimide, N,N′-di-2,4,6-triisopropylphenylcarbodiimide, N,N′-di-2,4,6-triisobutylphenylcarbodiimide, diisopropylcarbodiimide, dimethlylcarbodiimide, diisobutylcarbodiimide, dioctylcarbodiimide, t-butylisopropyilarbodiimide, di-β-naphthylcarbodiimide and di-t-butylcarbodiimide.

Examples of the commercially available products of carbodiimide compounds include monocarbodiimides, each of which has one carbodiimide group in one and the same molecule thereof, such as EM-160 manufactured by Matsumoto Yushi-Seiyaku Co., Ltd., and Stabaxol I manufactured by Rhein Chemie Corp. Alternatively, examples of the commercially available products of carbodiimide compounds include polycarbodiimides, each of which has two or more polycarbodiimide groups in one and the same molecule thereof, such as EN-180 manufactured by Matsumoto Yushi-Seiyaku Co,, Ltd., Stabaxol P manufactured by Rhein Chemie Corp. and Carbodilite LA-1 manufactured by Nisshinbo Chemical Inc.

Among these, monocarbodiimides are preferable and N,N′-di-2,6-diisopropylphenylcarbodiimide is more preferable because the use thereof in combination with stannic oxide results in remarkable improvement effect of the moisture-heat durability of the polylactic acid resin.

The content of the carbodiimide compound in the resin composition is, in view of the above-described improvement effect of the moisture-heat durability, preferably 0.1 to 10 parts by mass, more preferably 0.2 to 8.0 parts by mass and furthermore preferably 0.3 to 5.0 parts by mass, in relation to 100 parts by mass of the polylactic acid resin (A). When the content of the carbodiimide compound is less than 0.1 part by mass, such an improvement effect of the moisture-heat durability as described above is not sufficiently obtained. On the other hand, when the content of the carbodiimide compound exceeds 10 parts by mass, the improvement effect of the moisture-heat durability is saturated, and additionally the physical properties other than the moisture-heat durability are adversely affected.

The polylactic acid resin composition of the present invention uses as the polylactic acid resin (A) a polylactic acid having a D-isomer content falling in a specific range, and hence can sufficiently improve the crystallinity thereof, but may also include a crystal nucleating agent for the purpose of improving the crystallinity (mainly, crystallization rate).

The crystal nucleating agent is preferably at least one selected from the group consisting of an organic amide compound, an organic hydrazide compound, a carboxylic acid ester compound, an organosulfonic acid salt, a phthalocyanine compound, a melamine compound and an organophosphonic acid salt. Among these, from the viewpoint of the crystallisation rate, the organosulfonic acid salt and the organic amide compound are preferable.

As the organosulfonic acid salt, various organosulfonic acid salts such as sulfoisophthalic acid salts can be used. From the viewpoint of the crystallization promotion effect, preferable among these are metal salts of dimethyl 5-sulfoisophthalate. As the metal salts, preferable are the barium salt, the calcium salt, the strontium salt, the potassium salt, the rubidium salt and the sodium salt. Examples of the commercially available products of the organosulfonic acid salt include LAK403 manufactured by Takemoto Oil & Fat Co., Ltd.

As the organic amide compound, various organic amide compounds can be used; however, from the viewpoint of the dispersibility in the resin and the heat resistance, N,N′,N″-tricyclohexyltrimesic acid amide and N,N′-ethylene-bis(12-hydroxystearic acid amide) are preferable. Examples of the commercially available products of the organic amide compound include A-S-AT-530SF manufactured by Itoh Oil Chemicals Co., Ltd.

The content of the crystal nucleating agent in the resin composition is, in view of the improvement effect of the crystallinity, preferably 0.03 to 5 parts by mass, more preferably 0.1 to 4 parts by mass and particularly preferably 0.5 to 3 parts by mass, in relation to 100 parts by mass of the polylactic acid resin (A).

When the content of the crystal nucleating agent is less than 0.93 part by mass, the effect to further improve the crystallinity of the polylactic acid resin (A) comes to be poor. When the content of the crystal nucleating agent exceeds 5 parts by mass, the effect due to the crystal nucleating agent is saturated to be economically disadvantageous, and additionally the amount of the residue after biodegradation is increased to be environmentally unfavorable.

To the polylactic acid resin composition of the present invention, within the ranges not impairing the advantageous effects of the present invention, the following additives may be added: the additives such as a plasticizer, a heat stabilizer, an antioxidant, a filler, a pigment, an antiweathering agent, a flame retardant, a lubricant, a mold release agent and an antistatic agent.

Examples of the plasticizer include a polyester plasticizer, a glycerin plasticizer, a polycarboxylic acid ester plasticizer, a phosphoric acid ester plasticizer, a polyalkylene glycol plasticizer and an epoxy plasticizer.

Examples of the heat stabilizer and the antioxidant include hindered phenols, phosphorus compounds, hindered amines, sulfur compounds, copper compounds, halides of alkali metals and vitamin E.

Examples of the filler include inorganic fillers and organic fillers. Examples of the inorganic filler include talc, sine carbonate, wollastonite, silica, aluminum oxide, magnesium oxide, calcium silicate, sodium aluminate, calcium aluminate, sodium aluminosilicate, magnesium silicate, glass balloon, carbon black, zinc oxide, antimony trioxide, zeolite, metal fiber, metal whisker, ceramic whisker, potassium titanate, boron nitride, graphite, glass fiber and carbon fiber. Examples of the organic filler include naturally-occurring polymers such as starch, cellulose fine powder, wood powder, bean curd refuse, rice hull, bran and kenaf, and modified substances of these.

Examples of the flame retardant include halogen flame retardants, phosphorus flame retardants, and inorganic flame retardants; however, in view of the environment, it is preferable to use non-halogen flame retardants. Examples of the non-halogen flame retardant include phosphorus flame retardants, hydrated metal compounds (aluminum hydroxide, magnesium hydroxide), N-containing compounds (melamine compounds and guanidine compounds) and inorganic compounds (borates, Mo-containing compounds).

As the lubricant, various carboxylic acid compounds can be used, and among others, various fatty acid metal salts, in particular, magnesium stearate and calcium stearate are suitably used.

As the mold release agent, various carboxylic acid compounds can be used, and among others, various fatty acid esters and various fatty acid amides are suitably used.

Next, examples of the method for producing the polylactic acid resin composition of the present invention include: a first method in which the tin oxide (B) and the additives (such as an impact resistance improver, a carbodiimide compound and a crystal nucleating agent) used, if necessary, are added at the time of polymerization of the polylactic acid resin (A); a second method in which the tin oxide (B) and the additives used if necessary are melt-kneaded with the polylactic acid resin (A); and a third method in which the tin oxide (B) and the additives used if necessary are added at the time of molding.

In the first method, as the reaction vessel for performing melt ring-opening polymerization, a vertical reactor or a horizontal reactor equipped with a helical ribbon blade or a high-viscosity stirring blade are used. The reaction vessels may be used each alone or two or more of the reaction vessels may be used in a parallel arrangement. The reaction vessel may be any of a continuous type reaction vessel, a batch type reaction vessel and a semi-batch type reaction vessel, or a combination of two or more of these.

In the second and third methods, for example, the following methods are used: a method in which the additives are beforehand dry blended with the polylactic acid resin (A), and the resulting mixture is fed to a common kneader or a common molding machine; and a method in which the additives are added by using a side feeder at the time of melt kneading. In general, other additives such as a plasticizer or a beat stabilizer are preferably added at the time of melt kneading or at the time of polymerization.

In the second method, common kneaders such as a single screw extruder, a double screw extruder, a roll kneader and a Brabender kneader can be used. From the viewpoint of enhancing the mixing uniformity or dispersiveness, it is preferable to use a double screw extruder.

The molded body of the present invention is obtained by molding the polylactic acid resin composition of the present invention. Among others, the molded body is preferably molded by using only the polylactic acid resin composition of the present invention.

Examples of the molded body of the present invention include various molded bodies obtained by using the polylactic acid resin composition of the present invention with a heretofore known technique such as an injection molding method, a blow molding method or an extrusion molding method. The polylactic acid resin composition of the present invention is fast in crystallization rate, the molding cycle in obtaining a molded body can be shortened, and is excellent in molding processability.

As the injection molding method, in addition to a common injection molding method, for example, a gas injection molding method and an injection press method are used. An example of the suitable injection molding condition is such that the cylinder temperature is equal to or higher than the melting point (Tm) or the flow initiation temperature of the polylactic acid resin composition, and is preferably within a range from 160 to 230° C. When the cylinder temperature is too low, molding failure or overload of the apparatus tends to occur due to the degradation of the fluidity of the resin. When the cylinder temperature is too high, unpreferably, the polylactic acid resin is decomposed, and the obtained molded article undergoes strength decrease, coloration or the like in a disadvantageous manner.

In the present invention, the die temperature in the injection molding is preferably (Tg−10° C.) or lower, in the case where the die temperature is set to be equal to or lower than the glass transition temperature (Tg) of the polylactic acid resin composition. In order to promote the crystallization for the purpose of improving the rigidity and the heat resistance of the resin composition, the die temperature can be set at Tg or higher and (Tm−30° C.) or lower.

Examples of the blow molding method include a direct blow method in which molding is directly conducted from material chips, an injection blow molding method in which a preliminary molded article (bottomed parison) is first obtained by injection molding and then the preliminary molded article is subjected to blow molding and a stretching blow molding method. Additionally, either of the following methods can be adopted: a hot parison method in which after molding of a preliminary molded article, successively blow molding is conducted, and a cold parison method in which a preliminary molded article is once cooled and then heated again to be subjected to below molding.

As the extrusion molding method, a T-die method, a round die method or the like may be applied. The molding temperature is required to be equal to or higher than the melting point or the flow initiation temperature of the polylactic acid resin as the material, and preferably falls within a range from 180 to 230° C. and more preferably within a range from 190 to 220° C. When the molding temperature is too low, operation tends to be unstable or overload tends to occur. When the molding temperature is too high, the polylactic acid resin is decomposed, and the extrusion molded body undergoes strength decrease, coloration or the like in a disadvantageous manner.

Extrusion molding enables to produce sheets, pipes and the like. Specific applications of the sheets or pipes obtained by the extrusion molding method include original sheets for use in deep-draw molding, original sheets for use in batch foaming, cards such as credit cards, sheets laid under writing paper, transparent file holders, straws, agricultural and gardening rigid pipes. Additionally, by further applying deep-draw molding such as vacuum molding, pneumatic molding or vacuum-pneumatic molding to sheets, there can be produced food containers, agricultural and gardening containers, blister pack containers, press-through pack containers and the like.

The molded article of the present invention is obtained by molding the polylactic acid resin composition of the present invention excellent in heat resistance and moisture-heat durability, and hence is suitably used for components for use in automobiles. Specific examples of the components for use in automobiles include a bumper member, an instrument panel, a trim, a torque control lever, a safety belt component, a register blade, a washer lever, a window regulator handle, a knob of a window regulator handle, a passing light lever, a sun visor bracket, a console box, a trunk cover, a spare tire cover, a ceiling material, a floor material, an inner plate, a seat material, a door panel, a door board, a steering wheel, a rearview mirror housing, an air duct panel, a window molding fastener, a speed cable liner, a sun visor bracket, a headrest rod holder, various motor housings, various plates and various panels.

The molded body of the present invention can be suitably used in applications requiring heat resistance and moisture-heat durability, such as the enclosures and various components for office machines, household electric appliances and the like. Specific examples of the office machines include the following components used in a printer, a copying machine or a fax: a front cover and a rear cover in the casing, a paper feed tray, a paper discharge tray, a platen, an interior cover and a toner cartridge.

The molded body of the present invention can also be suitably used in applications requiring moisture-heat durability, such as electronic and electric components, medical supplies, food, household and office articles, OA machines, building material components and furniture components.

The molded body of the present invention can be suitably used for: eating utensils such as dishes, bowls, pots, chopsticks, spoons, forks and knives; fluid containers; caps for containers; office supplies such as rules, writing materials, transparent cases and CD cases; daily commodities such as sink-corner strainers, trash containers, basins, toothbrushes, combs and clothes hangers; agricultural and gardening articles such as flower pots and seedling raising pots; and various toys such as plastic models.

### EXAMPLES

Hereinafter, Examples of the present invention is specifically described; however, the present invention is not limited to these Examples.

The measurements and evaluations of the values of the various properties in Examples were performed as follows.

(1) D-Isomer Content in Polylactic Acid Resin

An obtained resin composition was weighed in an amount of 0.3 g, added to 6 mL of a 1N potassium hydroxide/methanol solution and sufficiently stirred at 65° C. To the resulting solution, 450 μL of sulfuric acid was added and stirred at 65° C. to decompose the polylactic acid; 5 mL of the resulting solution was measured off as a sample.

With the sample, 3 mL of pure water and 13 mL of methylene chloride were mixed and the resulting mixture was shaken up. The mixture was allowed to stand for separation, and then about 1.5 mL of the lower organic layer was sampled, filtered with a disc filter having a pore size of 0.45 μm for HPLC, and then subjected to a gas chromatographic measurement with the HP-6890 Series GC system manufactured by Hewlett-Packard Co. The proportion (%) of the peak area of methyl D-lactate in the total peak area of the methyl lactate was derived, and was taken as the D-isomer content (mol %) in the polylactic acid resin.

(2) Melt Flow Rate (MFR) of Polylactic Acid Resin

The melt flow rate was measured according to JIS K-7210, at 190° C., under a load of 21.2 N.

(3) Content of Tin Oxide

An obtained resin composition was analyzed with an ICP analysis apparatus, and the content of tin oxide was determined by quantitatively determining the content of tin with a quantitative analysis method using a calibration curve. The sample was prepared by microwave-wet decomposition.

(4) Deflection Temperature Under Load (Heat Resistance)

An obtained specimen was used, the deflection temperature under load (DTUL) was measured according to ISO 75-1, 2, under a load of 0.45 MPa.

(5) Molding Cycle (Crystallization Rate)

At the time of injection molding for obtaining a specimen, the resin composition is injected into the die (filled and allowed to dwell in the die) and cooled, and the time (counted from the time of injection: in seconds) elapsed until the molded body comes to be able to be taken out from the die without fixing to the die, or the time (counted from the time of injection: in seconds) elapsed until the molded body comes to be able to be taken out from the die without undergoing resistance was defined as the molding cycle. In this case, the upper limit of the molding cycle was set at 180 seconds.

(6) Flexural Rupture Strength Retention Rate (Moisture-Heat Durability)

By using an obtained specimen, the flexural rupture strength (the flexural rupture strength before the moisture-heat treatment) was measured according to ISO 178, by applying a load at a deformation rate of 2 mm/min.

For the specimen of a resin composition to which no carbodiimide compound was added, the flexural rupture strength (the flexural rupture strength I after the moisture-heat treatment) of the specimen was measured, in the same manner as described above, after the specimen was exposed for 600 hours to a high temperature-high humidity environment of 50° C. and 95% RH.

Then, on the basis of the following formula, the flexural rupture strength retention rate I was calculated.

Flexural rupture strength retention rate I (%)=[(flexural rupture strength I after moisture-heat treatment)/(flexural rupture strength before moisture-heat treatment)]×100

For the specimen of a resin composition to which a carbodiimide compound was added, the flexural rupture strength (the flexural rupture strength II after the moisture-heat treatment) of the specimen was measured, in the same manner as described above, after the specimen was exposed for 3000 hours to a high temperature-high humidity environment of 60° C. and 95% RH.

Then, on the basis of the following formula, the flexural rupture strength retention rate II was calculated.

Flexural rupture strength retention rate II (%)=[(flexural rupture strength II after moisture-heat treatment)/(flexural rupture strength before moisture-heat treatment)]×100

(7) Charpy Impact Strength (Impact Resistance)

By using an obtained specimen with a V-shaped notch, the Chrapy impact strength of the specimen was measured according to ISO 179-1.

(8) Haze (Transparency)

By using an obtained plate-shaped specimen, the base of the specimen was measured, according to JIB K-7105, with a haze meter (NDH2000, manufactured by Nippon Denshoku Industries Co., Ltd.).

The materials used in Examples and Comparative Examples are as follows.

[Polylactic Acid Resins]

A-1: D-isomer content 0.1 mol %, MFR=8 g/10 min (S-12, manufactured by Toyota Motor Corp.)

A-2: D-isomer content=1.4 mol %, MFR=10 g/10 min (TE-4000, manufactured by Unitika Ltd.)

A-3: D-isomer content=0.3 mol %, MFR=10 g/10 min (obtained in Production Examples 1, manufactured by Unitika ltd.)

A-4: D-isomer content=2.0 mol %, MFR=8 g/10 min (mixture composed of (A-2) and (X-1) in a ratio of 75:25)

X-1: D-isomer content=4.0 mol %, MFR=4 g/10 min (4042D, manufactured by NatureWorks LLC)

### Production Example 1

In a glass tube, L-lactide was placed, and the air in the system inside the glass tube was replaced with nitrogen. Next, as a polymerization catalyst, 0.01 part by mass of stannous octoate was placed in the glass tube, and the resulting reaction mixture was increased in

temperature to 150° C. in nitrogen atmosphere. After the content of the glass tube was melted, stirring of the content was started and the content was further increased in temperature to 190° C. to undergo polymerization (melt polymerization). The reaction time was set at 2 hours. Subsequently, the obtained polymerization reaction product was vacuum-dried at 130° C. for 30 hours, and the lactide remaining in the polymerization product was removed. Thus, a polylactic acid (A-3) having a D-isomer content of 0.3 mol %, a MFR of 10 g/10 min, and a weight average molecular weight of 140,000 was obtained.

[Tin Compounds]

B-1: Stannic oxide (manufactured by Showa Chemical Industry Co., Ltd.)

Y-1: Tin powder (Manufactured by Kishida Chemical Co., Ltd.)

Y-2: Stannous chloride (manufactured by Ishizu Pharmaceutical Co., Ltd.)

[Crystal nucleating Agent]

D-1: Barium organosulfonate crystal nucleating agent (LAK403, manufactured by Takemoto Oil & Fat Co., Ltd.)

[Carbodiimide Compound]

E-1: Monocarbodiimide compound (EK160, manufactured by Matsumoto Yushi-Seiyaku Co., Ltd.)

[Impact Resistance Improvers]

C-1: Core-shell graft copolymer (core component: acrylic rubber, shell component: methyl (meth)acrylate polymer) (Paraloid BPM-515, manufactured by Rohm and Haas Corp.)

C-2: Core-shell graft copolymer (core component: silicone-acrylic rubber, shell component: polymer having a glycidyl group-containing vinyl unit) (Metablen S-2200, manufactured by Mitsubishi Rayon Co., Ltd.)

C-3: Core-shell graft copolymer (core component: butadiene rubber, shell component: methyl (meth)acrylate polymer) (Kane Ace B-564, manufactured by Kaneka Corp.)

C-4: Ultrahigh molecular weight (meth)acrylic acid ester copolymer (Metablen P-531, weight average molecular weight: 4,500,000, manufactured by Mitsubishi Rayon Co., Ltd.)

C-5: Methyl methacrylate-n-butyl acrylate copolymer (Kurarity LA2140e, content of n-butyl acrylate: 77% by mass, manufactured by Kuraray Co., Ltd.)

C6: Methyl methacrylate-n-butyl acrylate copolymer (Kurarity LA2250, content of n-butyl acrylate: 67% by mass, manufactured by Kuraray Co., Ltd.)

[Thermoplastic Resins Other Than Polylactic Acid Resins]

M-1: PP resin (Novatec PP BC-03C, manufactured by Japan Polypropylene Corp.)

M-2: PB resin (Novatec HD HJ490, manufactured by Japan Polyethylene Corp.)

M-3: PMMA resin (Acrypet VH-001, manufactured by Mitsubishi Rayon Co., Ltd.)

M-4: ABS resin (Techno ABS 170, manufactured by Techno Polymer Co., Ltd.)

M-5: PC resin (Calibre 200-13, manufactured by Sumitomo Dow Ltd.)

M-6: Methyl methacrylate copolymer (Modiper A4200, manufactured by NOF Corp.)

### Example 1 and Comparative Example 1

The resin compositions and molded bodies of No. 1 to No. 32 of Example 1 shown in Tables 1 and 3 and the resin compositions and molded bodies of No. 1 to No. 15 of Comparative Example 1 shown in Tables 2 and 3 were prepared by the following methods.

The materials shown in Tables 1 to 3 were dry blended in the proportions shown in Tables 1 to 3, and the resulting mixtures were fed to a double screw extruder (TEM26SS, manufactured by Toshiba Machine Co., Ltd.) and melt kneaded under the conditions of a barrel temperature of 190° C., a number of screw rotations of 150 rpm and a discharge rate of 15 kg/h. The resulting melt kneaded mixtures were extruded into strands from a die with three holes (diameter: 0.4 mm), and the resulting strands were out to obtain pellets. The obtained pellets were dried at a temperature of 60° C. for 48 hours with a vacuum dryer (DP83, manufactured by Yamato Science Co., Ltd.), and thus pellet-shaped polylactic acid resin compositions were obtained.

The obtained pellet-shaped polylactic acid resin compositions were injection molded with an injection molding machine (model NEX-110, manufactured by Nissei Plastic Industrial Co., Ltd.) under the conditions of a cylinder temperature of 160 to 200° C. and a die temperature of 100° C. to prepare specimens (molded bodies) (length: 80 mm, width: 10 mm, thickness: 4 mm) in accordance with ISO, for measurement of general physical properties. The specimens were used for the above-described (4) measurement of the deflection temperature under load, the above-described (5) measurement of the molding cycle and the above-descried (6) measurement of the flexural rupture strength.

The resin composition and molded body of No. 33 of Example 1 shown in Table 1 were prepared by the following method. No. 33 is an example for obtaining a resin composition by a method in which tin oxide is added at the time of polymerization of the polylactic acid resin.

In a glass tube, L-lactide and the tin compound (B-1) were placed, and the resulting mixture was increased in temperature to 150° C. in nitrogen atmosphere. At the time when the content was melted, the stirring of the content was started, the content was further increased in temperature to 190° C. to undergo polymerization (melt polymerization). The reaction time was set at 2 hours. Subsequently, the obtained polymerization reaction product was vacuum-dried at 130° C. for 30 hours, and the lactide remaining in the polymerization product was removed. Thus, a polylactic acid resin composition including the tin compound (B-1) was obtained. The polylactic acid resin in the polylactic acid resin composition was found to have a D-isomer content of 0.2 mol %, a weight average molecular weight of 115,000 and a MFR of 15.

The obtained polylactic acid resin composition was injection molded by the same method as described above to prepare a specimen (molded body) (length: 80 mm, width: 10 mm, thickness: 4 mm) in accordance with ISO, for measurement of general physical properties. The specimen was used for the above-described (4) measurement of the deflection temperature under load, the above-described (5) measurement of the molding cycle and the above-described (6) measurement of the flexural rupture strength.

The evaluation results thus obtained are shown in Tables 1 to 3.

TABLE 1

| | | | | Example 1 | | | | | | | | | | | | |
|---|---|---|---|---|---|---|---|---|---|---|---|---|---|---|---|---|
| | | | | 1 | 2 | 3 | 4 | 5 | 6 | 7 | 8 | 9 | 10 | 11 | 12 | 13 |
| Composition of | Polylactic acid | A-1 | parts by | 100 | 100 | 100 | 100 | 100 | 100 | 100 | 100 | 100 | 60 | 60 | 60 | 60 |
| resin | resins | | mass | | | | | | | | | | | | | |
| composition | | A-2 | parts by | | | | | | | | | | 40 | 40 | 40 | 40 |
| | | | mass | | | | | | | | | | | | | |
| | | A-3 | parts by | | | | | | | | | | | | | |
| | | | mass | | | | | | | | | | | | | |
| | | A-4 | parts by | | | | | | | | | | | | | |
| | | | mass | | | | | | | | | | | | | |
| | Tin | B-1 | parts by | 0.005 | 0.01 | 0.05 | 0.1 | 0.5 | 1 | 3 | 10 | 5 | 0.1 | 1 | 3 | 5 |
| | compounds | | mass | | | | | | | | | | | | | |
| | | Y-1 | parts by | | | | | | | | | | | | | |
| | | | mass | | | | | | | | | | | | | |
| | | Y-2 | parts by | | | | | | | | | | | | | |
| | | | mass | | | | | | | | | | | | | |
| | Crystal | D-1 | parts by | | | | | | | | | | | | | |
| | nucleating | | mass | | | | | | | | | | | | | |
| | agent | | | | | | | | | | | | | | | |
| | Carbodiimide | E-1 | parts by | | | | | | | | | | | | | |
| | compound | | mass | | | | | | | | | | | | | |

| | | | | | | | | | | | | | | | |
|---|---|---|---|---|---|---|---|---|---|---|---|---|---|---|---|
| Physical | D-isomer content | mol % | 0.1 | 0.1 | 0.1 | 0.1 | 0.1 | 0.1 | 0.1 | 0.1 | 0.1 | 0.6 | 0.6 | 0.6 | 0.6 |
| properties | of polylactic acid | | | | | | | | | | | | | | |
| | resin | | | | | | | | | | | | | | |
| | Molding cycle | sec | 60 | 55 | 53 | 50 | 43 | 40 | 38 | 34 | 36 | 57 | 49 | 46 | 45 |
| | Deflection | ° C. | 115 | 119 | 120 | 123 | 123 | 124 | 125 | 128 | 127 | 115 | 117 | 119 | 120 |
| | temperature under | | | | | | | | | | | | | | |
| | load | | | | | | | | | | | | | | |
| | Flexural rupture | % | 71 | 75 | 77 | 77 | 80 | 82 | 85 | 90 | 88 | 72 | 75 | 77 | 79 |
| | strength retention | | | | | | | | | | | | | | |
| | rate I | | | | | | | | | | | | | | |

| | | | | Example 1 | | | | | | | | | | | | | |
|---|---|---|---|---|---|---|---|---|---|---|---|---|---|---|---|---|---|
| | | | | 14 | 15 | 16 | 17 | 18 | 19 | 20 | 21 | 22 | 23 | 24 | 25 | 26 | 33 |
| Composition of | Polylactic acid | A-1 | parts by | | | | 100 | 100 | 60 | 60 | | | | | | | 100 |
| resin | resins | | mass | | | | | | | | | | | | | | |
| composition | | A-2 | parts by | 100 | 100 | 100 | | | 40 | 40 | 100 | 100 | | | | | |
| | | | mass | | | | | | | | | | | | | | |
| | | A-3 | parts by | | | | | | | | | | 100 | 100 | 100 | | |
| | | | mass | | | | | | | | | | | | | | |
| | | A-4 | parts by | | | | | | | | | | | | | 100 | |
| | | | mass | | | | | | | | | | | | | | |
| | Tin | B-1 | parts by | 0.1 | 1 | 3 | 0.1 | 1 | 0.1 | 1 | 0.1 | 1 | 0.1 | 0.5 | 1 | 1 | 1 |
| | compounds | | mass | | | | | | | | | | | | | | |
| | | Y-1 | parts by | | | | | | | | | | | | | | |
| | | | mass | | | | | | | | | | | | | | |
| | | Y-2 | parts by | | | | | | | | | | | | | | |
| | | | mass | | | | | | | | | | | | | | |
| | Crystal | D-1 | parts by | | | | 1 | 1 | 1 | 1 | 1 | 1 | | | | | |
| | nucleating | | mass | | | | | | | | | | | | | | |
| | agent | | | | | | | | | | | | | | | | |
| | Carbodiimide | E-1 | parts by | | | | | | | | | | | | | | |
| | compound | | mass | | | | | | | | | | | | | | |

| | | | | | | | | | | | | | | | | |
|---|---|---|---|---|---|---|---|---|---|---|---|---|---|---|---|---|
| Physical | D-isomer content | mol % | 1.4 | 1.4 | 1.4 | 0.1 | 0.1 | 0.6 | 0.6 | 1.4 | 1.4 | 0.3 | 0.3 | 0.3 | 2 | 0.2 |
| properties | of polylactic acid | | | | | | | | | | | | | | | |
| | resin | | | | | | | | | | | | | | | |
| | Molding cycle | sec | 120 | 102 | 75 | 26 | 25 | 30 | 28 | 57 | 51 | 53 | 45 | 42 | 125 | 41 |
| | Deflection | ° C. | 103 | 105 | 108 | 130 | 131 | 123 | 125 | 126 | 126 | 120 | 121 | 122 | 100 | 123 |
| | temperature under | | | | | | | | | | | | | | | |
| | load | | | | | | | | | | | | | | | |
| | Flexural rupture | % | 60 | 64 | 68 | 80 | 84 | 75 | 78 | 62 | 67 | 75 | 77 | 80 | 59 | 81 |
| | strength retention | | | | | | | | | | | | | | | |
| | rate I | | | | | | | | | | | | | | | |

TABLE 2

| | | | | Comparative Example 1 | | | | | | | | |
|---|---|---|---|---|---|---|---|---|---|---|---|---|
| | | | | 1 | 2 | 3 | 4 | 5 | 6 | 7 | 8 | 9 |
| Composition | Polylactic acid | A-1 | parts by | | 100 | 100 | 100 | | | 100 | 100 | 100 |
| of resin | resins | | mass | | | | | | | | | |
| composition | | A-2 | parts by | | | | | | | | | |
| | | | mass | | | | | | | | | |
| | | X-1 | parts by | 100 | | | | 100 | 100 | | | |
| | | | mass | | | | | | | | | |
| | Tin compounds | B-1 | parts by | | 0.003 | | 15 | 1 | 1 | | | |
| | | | mass | | | | | | | | | |
| | | Y-1 | parts by | | | | | | | | 1 | |
| | | | mass | | | | | | | | | |
| | | Y-2 | parts by | | | | | | | | | 1 |
| | | | mass | | | | | | | | | |
| | Crystal | D-1 | parts by | | | | | | 1 | 1 | | |
| | nucleating agent | | mass | | | | | | | | | |
| | Carbodiimide | E-1 | parts by | | | | | | | | | |
| | compound | | mass | | | | | | | | | |

| | | | | | | | | | | | |
|---|---|---|---|---|---|---|---|---|---|---|---|
| Physical | D-isomer content of | mol % | 4 | 0.1 | 0.1 | 0.1 | 4 | 4 | 0.1 | 0.1 | 0.1 |
| properties | polylactic acid resin | | | | | | | | | | |
| | Molding cycle | sec | >180 | 80 | 85 | 35 | >180 | 105 | 28 | 47 | — |
| | Deflection temperature | ° C. | — | 109 | 108 | 125 | — | 71 | 128 | 113 | — |
| | under load | | | | | | | | | | |
| | Flexural rupture strength | % | — | 56 | 55 | 81 | — | 36 | 57 | 31 | — |
| | retention rate I | | | | | | | | | | |

TABLE 3

| | | | | Example 1 | | | | | | Comparative Example 1 | | | | | |
|---|---|---|---|---|---|---|---|---|---|---|---|---|---|---|---|
| | | | | 27 | 28 | 29 | 30 | 31 | 32 | 10 | 11 | 12 | 13 | 14 | 15 |
| Composition | Polylactic acid | A-1 | parts by | 100 | 100 | 100 | | | | 100 | 100 | 100 | | | |
| of resin | resins | | mass | | | | | | | | | | | | |
| composition | | A-2 | parts by | | | | 100 | 100 | 100 | | | | 100 | 100 | |
| | | | mass | | | | | | | | | | | | |
| | | X-1 | parts by | | | | | | | | | | | | 100 |
| | | | mass | | | | | | | | | | | | |
| | Tin compounds | B-1 | parts by | 0.1 | 0.1 | 0.1 | 0.1 | 0.1 | 0.1 | | | | | | 0.1 |
| | | | mass | | | | | | | | | | | | |
| | | Y-1 | parts by | | | | | | | | | | | | |
| | | | mass | | | | | | | | | | | | |
| | | Y-2 | parts by | | | | | | | | | | | | |
| | | | mass | | | | | | | | | | | | |
| | Crystal | D-1 | parts by | | 1 | | | | 1 | | 1 | | | 1 | 1 |
| | nucleating agent | | mass | | | | | | | | | | | | |
| | Carbodiimide | E-1 | parts by | 0.5 | 0.5 | 2 | 0.5 | 2 | 2 | 0.5 | 0.5 | 2 | 0.5 | 2 | 2 |
| | compound | | mass | | | | | | | | | | | | |

| | | | | | | | | | | | | | | |
|---|---|---|---|---|---|---|---|---|---|---|---|---|---|---|
| Physical | D-isomer content of | mol % | 0.1 | 0.1 | 0.1 | 1.4 | 1.4 | 1.4 | 0.1 | 0.1 | 0.1 | 1.4 | 1.4 | 4 |
| properties | polylactic acid resin | | | | | | | | | | | | | |
| | Molding cycle | sec | 52 | 24 | 53 | 121 | 122 | 52 | 87 | 27 | 87 | 150 | 55 | 108 |
| | Deflection temperature | ° C. | 119 | 122 | 118 | 116 | 113 | 114 | 116 | 115 | 109 | 107 | 112 | 70 |
| | under load | | | | | | | | | | | | | |
| | Flexural rupture | % | 84 | 87 | 99 | 54 | 70 | 74 | 45 | 47 | 66 | 28 | 40 | 43 |
| | strength retention rate II | | | | | | | | | | | | | |

The polylactic acid resin composition of Example 1 was found to be short in the molding cycle in obtaining a molded body, and the obtained molded body was found to be high in deflection temperature under load and excellent in heat resistance. The obtained molded body was found to be high in flexural rupture strength retention rate and also excellent in moisture-heat durability.

The polylactic acid resin compositions of Nos. 10 to 22 of Example 1 used the tin oxide (B) and an organic crystal nucleating agent in combination. Accordingly, the crystallinity was more improved and the molding was more shortened. The obtained molded body was also more excellent in heat resistance and high in flexural rupture strength retention rate, and was also improved in moisture-heat durability.

The polylactic acid resin compositions of Nos. 27 to 32 of Example 1 used the tin oxide (B) and a carbodiimide compound in combination. Accordingly, by the synergetic effect of both of these, the moisture-heat durability was extremely improved, and the obtained molded bodies were high in the flexural rupture strength retention rate II after a high temperature-high humidity treatment for 3000 hours.

On the other hand, the polylactic acid resin composition of No. 1 of Comparative Example 1 had a D-isomer content in the polylactic acid resin falling outside the range of the present invention and did not include the tin oxide (B). Accordingly, the crystallization rate was slow, and it was impossible to obtain, within a molding cycle of 180 seconds, a molded body free from deformation.

The polylactic acid resin composition of No. 2 of Comparative Example 1 had a D-isomer content in the polylactic acid resin falling within the range of the present invention, but was too small in the content of the tin oxide (B). The polylactic acid resin compositions of Nos. 3, 10, 12 and 13 of Comparative Example 1 had a D-isomer content in the polylactic acid resin falling within the range of the present invention, but did not include the tin oxide (B). Accordingly, in any of these polylactic acid resin compositions, the molding cycle was long, and the obtained molded body was poor both in heat resistance and in moisture-heat durability.

The polylactic acid resin composition of No. 4 of Comparative Example 1 had a D-isomer content in the polylactic acid resin falling within the range of the present invention, but was too large in the content of the tin oxide (B). Accordingly, both of the crystallinity and the moisture-heat durability were excellent, but was poor in dispersibility, and the obtained molded body was poor in exterior appearance sin such a way that the surface of the molded body had a feeling of roughness.

The polylactic acid resin composition of No. 5 of Comparative Example 1 included the tin oxide (B), but had a D-isomer content in the polylactic acid resin falling outside the range of the present invention. Accordingly, the crystallization rate was too slow, and it was impossible to obtain, within a molding cycle of 180 seconds, a molded body free from deformation. The polylactic acid resin compositions of Nos. 6 and 15 of Comparative Example 1 had a D-isomer content in the lactic acid resin falling outside the range of the present invention. Accordingly, the crystallization rate was slow, the molding cycle was long, and the obtained molded body was poor both in heat resistance and in moisture-heat durability.

The polylactic acid resin composition of No. 7 of Comparative Example 1 had a D-isomer content in the polylactic acid resin falling within the range of the present invention, but did not include the tin oxide (B). Accordingly, the obtained molded body was particularly poor in moisture-heat durability.

The polylactic acid resin composition of No. 8 of Comparative Example 1 had a D-isomer content in the polylactic acid resin falling within the range of the present invention, but included a tin compound other than the tin oxide (B). Accordingly, the obtained molded body was poor in moisture-heat durability.

The polylactic acid resin composition of No. 9 of Comparative Example 1 included stannous chloride as added thereto so as to degrade the viscosity thereof, and no molded body was able to be obtained.

The polylactic acid resin compositions of Nos. 11 and 14 of Comparative Example 1 had a D-isomer content in the polylactic acid resin falling within the range of the present invention, but did not include the tin oxide (B). Accordingly, the obtained molded bodies were poor in moisture-heat durability.

### Example 2 and Comparative Example 2

In present Example, resin compositions including the polylactic acid resin (A), the tin oxide (B) and the impact resistance improver (C) were investigated.

The resin compositions and the molded bodies of Nos. 1 to 24 of Example 2 shown in Table 4 and Nos. 1 to 9 of Comparative Example 2 shown in Table 5 were prepared by the following methods.

The materials shown in Tables 4 and 5 were dry blended in the proportions shown in Tables 4 and 5, and pellet-shaped polylactic acid resin compositions were obtained in the same manner as in Example 1.

The obtained pellet-shaped polylactic acid resin compositions were injection molded in the same manner as in Example 1, to prepare specimens (molded bodies) (length: 80 mm, width: 10 mm, thickness: 4 mm) in accordance with ISO, for measurement of general physical properties. The specimens were used for the above-described (4) measurement of the deflection temperature under load, the above-described (5) measurement of the molding cycle and the above-described (6) measurement of the flexural rupture strength.

Moreover, for Example 2 and Comparative Example 2, separately, the same molded bodies (length: 80 mm, width: 10 mm, thickness: 4 mm) as described above were prepared, and were each provided with a predetermined V-shaped notch. Thus, the specimens with a V-shaped notch were prepared and used for the measurement of the above-described (7) Charpy impact strength.

The evaluation results thus obtained are shown in Tables 4 and 5.

TABLE 4

| | | | | Example 2 | | | | | | | | | | | |
|---|---|---|---|---|---|---|---|---|---|---|---|---|---|---|---|
| | | | | 1 | 2 | 3 | 4 | 5 | 6 | 7 | 8 | 9 | 10 | 11 | 12 |
| Composition of | Polylactic | A-1 | parts by mass | 100 | 100 | 100 | 100 | 100 | 100 | 100 | 100 | 100 | 100 | 100 | 60 |
| resin composition | acid resins | A-2 | parts by mass | | | | | | | | | | | | 40 |
| | | X-1 | parts by mass | | | | | | | | | | | | |
| | Tin | B-1 | parts by mass | 1 | 1 | 1 | 1 | 1 | 1 | 1 | 1 | 0.5 | 3 | 5 | 1 |
| | compounds | Y-1 | parts by mass | | | | | | | | | | | | |
| | | Y-2 | parts by mass | | | | | | | | | | | | |
| | Impact | C-1 | parts by mass | 0.5 | 3 | 15 | | | | | | 3 | 3 | 3 | 3 |
| | resistance | C-2 | parts by mass | | | | 3 | | | | | | | | |
| | improvers | C-3 | parts by mass | | | | | 3 | | | | | | | |
| | | C-4 | parts by mass | | | | | | 5 | | | | | | |
| | | C-5 | parts by mass | | | | | | | 10 | | | | | |
| | | C-6 | parts by mass | | | | | | | | 10 | | | | |
| | Crystal | D-1 | parts by mass | | | | | | | | | | | | |
| | nucleating agent | | | | | | | | | | | | | | |
| | Carbodiimide | E-1 | parts by mass | | | | | | | | | | | | |
| | compound | | | | | | | | | | | | | | |
| Physical properties | D-isomer content of | | mol % | 0.1 | 0.1 | 0.1 | 0.1 | 0.1 | 0.1 | 0.1 | 0.1 | 0.1 | 0.1 | 0.1 | 0.6 |
| | polylactic acid resin | | | | | | | | | | | | | | |
| | Molding cycle | | sec | 41 | 41 | 42 | 38 | 43 | 41 | 47 | 45 | 44 | 38 | 36 | 45 |
| | Deflection | | ° C. | 126 | 125 | 108 | 126 | 121 | 126 | 111 | 115 | 123 | 127 | 128 | 123 |
| | temperature under | | | | | | | | | | | | | | |
| | load | | | | | | | | | | | | | | |
| | Flexural rupture | | % | 84 | 85 | 87 | 86 | 83 | 90 | 91 | 93 | 82 | 87 | 90 | 82 |
| | strength retention | | | | | | | | | | | | | | |
| | rate I | | | | | | | | | | | | | | |
| | Flexural rupture | | % | | | | | | | | | | | | |
| | strength retention | | | | | | | | | | | | | | |
| | rate II | | | | | | | | | | | | | | |
| | Charpy impact | | kJ/m² | 13 | 18 | 30 | 17 | 16 | 15 | 18 | 14 | 16 | 18 | 17 | 16 |
| | strength | | | | | | | | | | | | | | |
| | | | | Example 2 | | | | | | | | | | | |
| | | | | 13 | 14 | 15 | 16 | 17 | 18 | 19 | 20 | 21 | 22 | 23 | 24 |
| Composition of | Polylactic | A-1 | parts by mass | 60 | 60 | | | | 100 | 100 | 100 | 100 | 100 | 100 | 100 |
| resin composition | acid resins | A-2 | parts by mass | 40 | 40 | 100 | 100 | 100 | | | | | | | |
| | | X-1 | parts by mass | | | | | | | | | | | | |
| | Tin | B-1 | parts by mass | 1 | 1 | 1 | 1 | 1 | 1 | 1 | 1 | 1 | 1 | 1 | 1 |
| | compounds | Y-1 | parts by mass | | | | | | | | | | | | |
| | | Y-2 | parts by mass | | | | | | | | | | | | |
| | Impact | C-1 | parts by mass | | | 3 | | | 3 | | | 3 | | | 3 |
| | resistance | C-2 | parts by mass | | | | | | | | | | | | |
| | improvers | C-3 | parts by mass | | | | | | | | | | | | |
| | | C-4 | parts by mass | 5 | | | 5 | | | 5 | | | 5 | | |
| | | C-5 | parts by mass | | 10 | | | 10 | | | 10 | | | 10 | |
| | | C-6 | parts by mass | | | | | | | | | | | | |
| | Crystal | D-1 | parts by mass | | | | | | 1 | 1 | 1 | | | | 1 |
| | nucleating agent | | | | | | | | | | | | | | |
| | Carbodiimide | E-1 | parts by mass | | | | | | | | | 0.5 | 0.5 | 0.5 | 0.5 |
| | compound | | | | | | | | | | | | | | |

| | | | | | | | | | | | | | | |
|---|---|---|---|---|---|---|---|---|---|---|---|---|---|---|
| Physical properties | D-isomer content of | mol % | 0.6 | 0.6 | 1.4 | 1.4 | 1.4 | 0.1 | 0.1 | 0.1 | 0.1 | 0.1 | 0.1 | 0.1 |
| | polylactic acid resin | | | | | | | | | | | | | |
| | Molding cycle | sec | 45 | 49 | 54 | 54 | 57 | 24 | 24 | 26 | 41 | 41 | 47 | 24 |
| | Deflection | ° C. | 124 | 109 | 117 | 118 | 107 | 128 | 129 | 116 | 125 | 126 | 111 | 127 |
| | temperature under | | | | | | | | | | | | | |
| | load | | | | | | | | | | | | | |
| | Flexural rupture | % | 87 | 89 | 69 | 71 | 74 | 87 | 93 | 95 | | | | |
| | strength retention | | | | | | | | | | | | | |
| | rate I | | | | | | | | | | | | | |
| | Flexural rupture | % | | | | | | | | | 91 | 94 | 98 | 98 |
| | strength retention | | | | | | | | | | | | | |
| | rate II | | | | | | | | | | | | | |
| | Charpy impact | kJ/m² | 14 | 17 | 12 | 11 | 15 | 19 | 17 | 20 | 18 | 15 | 18 | 19 |
| | strength | | | | | | | | | | | | | |

TABLE 5

| | | | | Comparative Example 2 | | | | | | | | |
|---|---|---|---|---|---|---|---|---|---|---|---|---|
| | | | | 1 | 2 | 3 | 4 | 5 | 6 | 7 | 8 | 9 |
| Composition | Polylactic | A-1 | parts by mass | 100 | | 100 | 100 | 100 | | 100 | 100 | 100 |
| of resin | acid resins | A-2 | parts by mass | | | | | | | | | |
| composition | | X-1 | parts by mass | | 100 | | | | 100 | | | |
| | Tin | B-1 | parts by mass | | 1 | | | | 1 | | | |
| | compounds | Y-1 | parts by mass | | | 1 | | | | 1 | | |
| | | Y-2 | parts by mass | | | | 1 | | | | 1 | |
| | Impact | C-1 | parts by mass | 3 | 3 | 3 | 3 | | | | | 3 |
| | resistance | C-2 | parts by mass | | | | | | | | | |
| | improvers | C-3 | parts by mass | | | | | | | | | |
| | | C-4 | parts by mass | | | | | 5 | 5 | 5 | 5 | |
| | | C-5 | parts by mass | | | | | | | | | |
| | | C-6 | parts by mass | | | | | | | | | |
| | Crystal | D-1 | parts by mass | | | | | | | | | |
| | nucleating | | | | | | | | | | | |
| | agent | | | | | | | | | | | |
| | Carbodiimide | E-1 | parts by mass | | | | | | | | | 0.5 |
| | compound | | | | | | | | | | | |

| | | | | | | | | | | | |
|---|---|---|---|---|---|---|---|---|---|---|---|
| Physical | D-isomer content of | mol % | 0.1 | 4 | 0.1 | 0.1 | 0.1 | 4 | 0.1 | 0.1 | 0.1 |
| properties | polylactic acid resin | | | | | | | | | | |
| | Molding cycle | sec | 84 | >180 | 47 | — | 84 | >180 | 47 | — | 85 |
| | Deflection temperature | ° C. | 107 | — | 115 | — | 109 | — | 116 | — | 107 |
| | under load | | | | | | | | | | |
| | Flexural rupture strength | % | 52 | — | 31 | — | 53 | — | 32 | — | |
| | retention rate I | | | | | | | | | | |
| | Flexural rupture strength | % | | | | | | | | | 47 |
| | retention rate II | | | | | | | | | | |
| | Charpy impact strength | kJ/m² | 14 | — | 14 | — | 13 | — | 13 | — | 14 |

The polylactic acid resin composition of Example 2 was short in the molding cycle at the time of obtaining a molded body, and the obtained molded body was high in deflection temperature under load and excellent in heat resistance. The obtained molded body was also high in flexural rupture strength retention rate and excellent in moisture-heat durability.

The polylactic acid resin composition of Example 2 used the tin oxide (B) and the impact resistance improver (C) in combination, and the content of the impact resistance improver (C) was within a range from 0.5 to 15 parts by mass in relation to 100 parts by mass of the polylactic acid resin (A). Accordingly, by the synergetic effect of both of these, the impact resistance was extremely improved. For example, the resin composition of No. 1 of Example 2 shown in Table 4, using the tin oxide (B) and the impact resistance improver (C) in combination was higher in the Charpy impact strength and exhibited an excellent impact resistance, as compared with the resin composition of No. 1 of Comparative Example 2 shown in Table 5, halving the same composition as in No. 1 of Example 2 except that the resin composition of No. 1 of Comparative Example 2 did not include the tin oxide (B). It is to be noted that the Charpy impact strength of the resin composition of No. 5 of Example 1 shown in Table 1 was 2.5 kJ/cm² which had the same composition as in No. 1 of Example 2 except that the resin composition of No. 5 of Example 1 did not include the impact resistance improver (C).

The polylactic acid resin compositions of Nos. 1, 5 and 9 of Comparative Example 2 had a D-isomer content in the polylactic acid resin falling within the range of the present invention, but did not include the tin oxide (B). Accordingly, in any of these polylactic acid resin compositions, the molding cycle was long, and the obtained molded body was poor both in heat resistance and in moisture-heat durability. Moreover, the resin compositions of Nos. 1, 5 and 9 of Comparative Example 2 were considerably poorer in the Charpy impact strength as compared, with the resin compositions of Nos. 2, 6 and 21 of Example 2, having the same composition as in the resin compositions of Nos. 1, 5 and 9 of Comparative Example 2, except that the resin compositions of Nos. 2, 6 and 21 of Example 2 included the tin oxide (B).

The polylactic acid resin compositions of Nos. 2 and 6 of Comparative Example 2 included the tin oxide (B), but had a D-isomer content in the polylactic acid resin falling outside the range of the present invention. Accordingly, the crystallisation rate was slow, and it was impossible to obtain, within a molding cycle of 180 seconds, a molded body free from deformation.

The polylactic acid resin compositions of Nos. 3 and 7 of Comparative Example 2 had a D-isomer content in the polylactic acid resin falling within the range of the present invention, but included the tin compound other than the tin oxide (B). Accordingly, the obtained molded bodies were poor in moisture-heat durability. Moreover, the resin compositions of Nos. 3 and 7 of Comparative Example 2 were considerably poorer in the Charpy impact strength as compared with the resin compositions of Nos. 2 and 6 of Example 2, having the same compositions as in the resin compositions of Nos. 3 and 7 of Comparative Example 2, respectively, except that the resin compositions of Nos. 2 and 6 Example 2 used the tin oxide (B) in place of the resin compound (Y-1).

The polylactic acid resin compositions of Nos. 4 and 8 of Comparative Example 2 included stannous chloride as added thereto so as to degrade the viscosities thereof, and no molded bodies were able to be obtained.

### Examples 3 to 6

In present Examples, the resin compositions including the polylactic acid resin (A), the tin oxide (B) and the thermoplastic resin (M) other than the polylactic acid resin (A) were investigated.

The resin compositions and the molded bodies of Nos. 1 to 26 of Examples 3 shown in Table 6, Nos. 1 to 9 of Example 4 shown in Table 7, Nos. 1 to 12 of Example 5 shown in Table 3 and Nos. 1 to 11 of Example 6 shown in Table 9 were prepared by the following methods.

The materials shown in Tables 6 to 9 were dry blended in the proportions shown in Tables 6 to 9, and pellet-shaped polylactic acid resin compositions were obtained in the same manner as in Example 1.

The obtained pellet-shaped polylactic acid resin compositions were injection molded in the same manner as in Example 1, to prepare specimens (molded bodies) (length: 80 mm, width: 10 mm, thickness: 4 mm) in accordance with ISO, for measurement of general physical properties. The specimens were used for the above-described (4) measurement of the deflection temperature under load, the above-described (5) measurement of the molding cycle and the above-descried (6) measurement of the flexural rupture strength.

For Examples 5 and 6, separately, the same molded bodies (length: 80 mm, width: 10 mm, thickness: 4 mm) as described above were prepared, and were each provided with a predetermined V-shaped notch. Thus, the specimens with a V-shaped notch were prepared and used for the measurement of the above-described (7) Charpy impact strength.

For Example 4, separately, the resin compositions were injection molded in the same manner as described above to prepare plate-shaped specimens (molded bodies) (length: 90 mm, width: 50 mm, thickness: 2 mm), and the plate-shaped specimens were used for the measurement of the above-described (8) haze.

It is to be noted, that in Examples 4 to 6, the cylinder temperature of the injection molding machine at the time of the production of these specimens was set at 160 to 230° C.

The evaluation results thus obtained are shown in Tables 6 to 9. The contents of the tin oxide (B) in Tables 6 to 9 are the quantities in relation to 100 parts by mass of the polylactic acid resin.

TABLE 6

| | | | | Example 3 | | | | | | | | | | | | |
|---|---|---|---|---|---|---|---|---|---|---|---|---|---|---|---|---|
| | | | | 1 | 2 | 3 | 4 | 5 | 6 | 7 | 8 | 9 | 10 | 11 | 12 | 13 |
| Composition of | Polylactic | A-1 | part by | 70 | 70 | 70 | 80 | 20 | 70 | 50 | 30 | | | 70 | 70 | 70 |
| resin composition | acid resins | | mass | | | | | | | | | | | | | |
| | | A-2 | parts by | | | | | | | | | 70 | 70 | | | |
| | | | mass | | | | | | | | | | | | | |
| | Polyolefin | M-1 | parts by | 30 | 30 | 30 | 20 | 80 | 30 | 50 | 70 | 30 | 30 | 30 | 30 | 30 |
| | resins | | mass | | | | | | | | | | | | | |
| | | M-2 | parts by | | | | | | | | | | | | | |
| | | | mass | | | | | | | | | | | | | |
| | Tin | B-1 | parts by | 0.1 | 0.5 | 1 | 1 | 1 | 5 | 0.5 | 0.5 | 0.5 | 1 | 0.1 | 0.1 | 0.1 |
| | compound | | mass | | | | | | | | | | | | | |
| | Crystal | D-1 | parts by | | | | | | | | | | | 1 | 1 | |
| | nucleating agent | | mass | | | | | | | | | | | | | |
| | Carbodiimide | E-1 | parts by | | | | | | | | | | | | 0.5 | 0.5 |
| | compound | | mass | | | | | | | | | | | | | |
| Physical properties | D-isomer content | | mol % | 0.1 | 0.1 | 0.1 | 0.1 | 0.1 | 0.1 | 0.1 | 0.1 | 1.4 | 1.4 | 0.1 | 0.1 | 0.1 |
| | of polylactic acid | | | | | | | | | | | | | | | |
| | resin | | | | | | | | | | | | | | | |
| | Molding cycle | | sec | 41 | 39 | 36 | 39 | 28 | 31 | 34 | 30 | 74 | 71 | 22 | 23 | 41 |
| | Deflection | | ° C. | 115 | 117 | 119 | 121 | 112 | 123 | 115 | 114 | 94 | 97 | 125 | 124 | 115 |
| | temperature under | | | | | | | | | | | | | | | |
| | load | | | | | | | | | | | | | | | |
| | Flexural rupture | | % | 85 | 89 | 93 | 90 | 100 | 96 | 98 | 100 | 71 | 75 | 86 | | |
| | strength retention | | | | | | | | | | | | | | | |
| | rate I | | | | | | | | | | | | | | | |
| | Flexural rupture | | % | | | | | | | | | | | | 95 | 93 |
| | strength retention | | | | | | | | | | | | | | | |
| | rate II | | | | | | | | | | | | | | | |
| | | | | Example 3 | | | | | | | | | | | | |
| | | | | 14 | 15 | 16 | 17 | 18 | 19 | 20 | 21 | 22 | 23 | 4 | 25 | 26 |
| Composition of | Polylactic | A-1 | part by | | 70 | 70 | 70 | 70 | 50 | 30 | | | 70 | 70 | 70 | |
| resin composition | acid resins | | mass | | | | | | | | | | | | | |
| | | A-2 | parts by | 70 | | | | | | | 70 | 70 | | | | 70 |
| | | | mass | | | | | | | | | | | | | |
| | Polyolefin | M-1 | parts by | 30 | | | | | | | | | | | | |
| | resins | | mass | | | | | | | | | | | | | |
| | | M-2 | parts by | | 30 | 30 | 30 | 30 | 50 | 70 | 30 | 30 | 30 | 30 | 30 | 30 |
| | | | mass | | | | | | | | | | | | | |
| | Tin | B-1 | parts by | 0.1 | 0.1 | 0.5 | 1 | 5 | 0.5 | 0.5 | 0.5 | 1 | 0.1 | 0.1 | 0.1 | 0.1 |
| | compound | | mass | | | | | | | | | | | | | |
| | Crystal | D-1 | parts by | 1 | | | | | | | | | 1 | 1 | | 1 |
| | nucleating agent | | mass | | | | | | | | | | | | | |
| | Carbodiimide | E-1 | parts by | 2 | | | | | | | | | | 0.5 | 0.5 | 2 |
| | compound | | mass | | | | | | | | | | | | | |

| | | | | | | | | | | | | | | | |
|---|---|---|---|---|---|---|---|---|---|---|---|---|---|---|---|
| Physical properties | D-isomer content | mol % | 1.4 | 0.1 | 0.1 | 0.1 | 0.1 | 0.1 | 0.1 | 1.4 | 1.4 | 0.1 | 0.1 | 0.1 | 1.4 |
| | of polylactic acid | | | | | | | | | | | | | | |
| | resin | | | | | | | | | | | | | | |
| | Molding cycle | sec | 47 | 43 | 40 | 38 | 34 | 36 | 32 | 76 | 73 | 23 | 23 | 42 | 49 |
| | Deflection | ° C. | 118 | 112 | 113 | 116 | 119 | 111 | 108 | 92 | 96 | 122 | 122 | 111 | 115 |
| | temperature under | | | | | | | | | | | | | | |
| | load | | | | | | | | | | | | | | |
| | Flexural rupture | % | | 87 | 93 | 95 | 98 | 99 | 100 | 74 | 78 | 88 | | | |
| | strength retention | | | | | | | | | | | | | | |
| | rate I | | | | | | | | | | | | | | |
| | Flexural rupture | % | 81 | | | | | | | | | | 96 | 94 | 84 |
| | strength retention | | | | | | | | | | | | | | |
| | rate II | | | | | | | | | | | | | | |

TABLE 7

| | | | | Example 4 | | | | | | | | |
|---|---|---|---|---|---|---|---|---|---|---|---|---|
| | | | | 1 | 2 | 3 | 4 | 5 | 6 | 7 | 8 | 9 |
| Composition | Polylactic | A-1 | parts by | 70 | 70 | 70 | 70 | 30 | 50 | | 70 | |
| of resin | acid resins | | mass | | | | | | | | | |
| composition | | A-2 | parts by | | | | | | | 70 | | 70 |
| | | | mass | | | | | | | | | |
| | PMMA resin | M-3 | parts by | 30 | 30 | 30 | 30 | 70 | 50 | 30 | 30 | 30 |
| | | | mass | | | | | | | | | |
| | Tin | B-1 | parts by | 0.1 | 0.5 | 1 | 3 | 0.5 | 0.5 | 0.5 | 0.1 | 0.1 |
| | compound | | mass | | | | | | | | | |
| | Carbodiimide | E-1 | parts by | | | | | | | | 0.5 | 2 |
| | compound | | mass | | | | | | | | | |

| | | | | | | | | | | | |
|---|---|---|---|---|---|---|---|---|---|---|---|
| Physical | D-isomer content of | mol % | 0.1 | 0.1 | 0.1 | 0.1 | 0.1 | 0.1 | 1.4 | 0.1 | 1.4 |
| properties | polylactic acid resin | | | | | | | | | | |
| | Molding cycle | sec | 44 | 40 | 35 | 32 | 31 | 35 | 84 | 45 | 85 |
| | Deflection temperature | ° C. | 93 | 94 | 96 | 98 | 90 | 92 | 86 | 93 | 85 |
| | under load | | | | | | | | | | |
| | Haze | % | 10 | 16 | 35 | 51 | 15 | 15 | 17 | 12 | 15 |
| | Flexural rupture | % | 83 | 87 | 91 | 93 | 96 | 92 | 72 | | |
| | strength retention rate I | | | | | | | | | | |
| | Flexural rupture | % | | | | | | | | 94 | 80 |
| | strength retention rate II | | | | | | | | | | |

TABLE 8

| | | | | Example 5 | | | | | | | | | | | |
|---|---|---|---|---|---|---|---|---|---|---|---|---|---|---|---|
| | | | | 1 | 2 | 3 | 4 | 5 | 6 | 7 | 8 | 9 | 10 | 11 | 12 |
| Composition | Polylactic acid | A-1 | parts by | 60 | 60 | 60 | 60 | 80 | 30 | | | 60 | 60 | 60 | |
| of resin | resin | | mass | | | | | | | | | | | | |
| composition | | A-2 | parts by | | | | | | | 60 | 60 | | | | 60 |
| | | | mass | | | | | | | | | | | | |
| | ABS resin | M-4 | parts by | 30 | 30 | 30 | 30 | 10 | 60 | 30 | 30 | 30 | 30 | 30 | 30 |
| | | | mass | | | | | | | | | | | | |
| | PMMA resin | M-3 | parts by | 10 | 10 | 10 | 10 | 10 | 10 | 10 | 10 | 10 | 10 | 10 | 10 |
| | | | mass | | | | | | | | | | | | |
| | Tin compound | B-1 | parts by | 0.1 | 0.5 | 1 | 5 | 1 | 1 | 0.1 | 1 | 0.1 | 0.1 | 0.1 | 0.1 |
| | | | mass | | | | | | | | | | | | |
| | Crystal nucleating | D-1 | parts by | | | | | | | | | 1 | | 1 | 1 |
| | agent | | mass | | | | | | | | | | | | |
| | Carbodiimide | E-1 | parts by | | | | | | | | | | 0.5 | 0.5 | 2 |
| | compound | | mass | | | | | | | | | | | | |

| | | | | | | | | | | | | | | |
|---|---|---|---|---|---|---|---|---|---|---|---|---|---|---|
| Physical | D-isomer content of | mol % | 0.1 | 0.1 | 0.1 | 0.1 | 0.1 | 0.1 | 1.4 | 1.4 | 0.1 | 0.1 | 0.1 | 1.4 |
| properties | polylactic acid resin | | | | | | | | | | | | | |
| | Molding cycle | sec | 42 | 38 | 34 | 30 | 37 | 30 | 77 | 74 | 22 | 43 | 22 | 48 |
| | Deflection temperature | ° C. | 97 | 98 | 97 | 97 | 110 | 93 | 86 | 89 | 100 | 93 | 100 | 101 |
| | under load | | | | | | | | | | | | | |
| | Charpy impact strength | kJ/m² | 23 | 23 | 22 | 20 | 15 | 29 | 18 | 19 | 23 | 23 | 23 | 21 |
| | Flexural rupture strength | % | 84 | 87 | 88 | 93 | 85 | 94 | 72 | 78 | 86 | | | |
| | retention rate I | | | | | | | | | | | | | |
| | Flexural rupture strength | % | | | | | | | | | | 92 | 95 | 82 |
| | retention rate II | | | | | | | | | | | | | |

TABLE 9

| | | | | Example 6 | | | | | | | | | | |
|---|---|---|---|---|---|---|---|---|---|---|---|---|---|---|
| | | | | 1 | 2 | 3 | 4 | 5 | 6 | 7 | 8 | 9 | 10 | 11 |
| Composition | Polylactic acid | A-1 | parts by mass | 50 | 50 | 50 | 50 | 50 | 70 | 30 | | 50 | 50 | |
| of resin | resins | A-2 | parts by mass | | | | | | | | 50 | | | 50 |
| composition | PC resin | M-5 | parts by mass | 50 | 50 | 50 | 50 | 50 | 30 | 70 | 50 | 50 | 50 | 50 |
| | Methyl methacrylate | M-6 | parts by mass | | | | | 5 | | | | | 5 | 5 |
| | copolymer | | | | | | | | | | | | | |
| | Tin compound | B-1 | parts by mass | 0.1 | 0.5 | 1 | 5 | 0.1 | 1 | 1 | 0.1 | 0.1 | 0.1 | 0.1 |
| | Crystal nucleating | D-1 | parts by mass | | | | | | | | | 1 | 1 | 1 |
| | agent | | | | | | | | | | | | | |
| | Carbodiimide | E-1 | parts by mass | | | | | | | | | | 0.5 | 2 |
| | compound | | | | | | | | | | | | | |

| | | | | | | | | | | | | | |
|---|---|---|---|---|---|---|---|---|---|---|---|---|---|
| Physical | D-isomer content of | mol % | 0.1 | 0.1 | 0.1 | 0.1 | 0.1 | 0.1 | 0.1 | 1.4 | 0.1 | 0.1 | 1.4 |
| properties | polylactic acid resin | | | | | | | | | | | | |
| | Molding cycle | sec | 41 | 40 | 38 | 34 | 35 | 43 | 34 | 73 | 22 | 22 | 44 |
| | Charpy impact strength | kJ/m² | 40 | 42 | 44 | 41 | 45 | 25 | 55 | 37 | 41 | 46 | 42 |
| | Deflection temperature | ° C. | 124 | 125 | 127 | 130 | 124 | 124 | 128 | 116 | 131 | 130 | 121 |
| | under load | | | | | | | | | | | | |
| | Flexural rupture strength | % | 87 | 92 | 93 | 96 | 96 | 84 | 96 | 73 | 89 | | |
| | retention rate I | | | | | | | | | | | | |
| | Flexural rapture strength | % | | | | | | | | | | 97 | 84 |
| | retention rate II | | | | | | | | | | | | |

The polylactic acid resin compositions of Examples 3 to 6 were short in the molding cycle at the time of obtaining a molded body, and the obtained molded bodies were nigh in deflection temperature under load and excellent in heat resistance. The obtained molded bodies were also high in flexural rupture strength retention rate and excellent in moisture-heat durability.

The polylactic acid resin compositions of Examples 3 to 6 used the polylactic acid resin (A) and the thermoplastic resin (M) other than the polylactic acid resin (A) in combination, and the mass ratio (A/M) of the polylactic acid resin (A) to the thermoplastic resin (M) was within a range from 20/80 to 80/20. Accordingly, the resin compositions having the excellent properties of the polylactic acid resin (A) and the excellent properties of the thermoplastic resin (M) were able to be obtained. The polylactic acid resin compositions of Examples 3 to 6 included one or two of PP resin, PE resin, PMMA resin, ABS resin and PC resin, but had satisfactory moldability. The polylactic acid resin composition of Example 4 included PMMA resin, and thus obtained satisfactory transparency. Each of the polylactic acid resin compositions of Example 5 and each of the polylactic acid compositions of Example 6 included ABS resin and PC resin, respectively, and thus, obtained satisfactory impact resistance.

1. A polylactic acid resin composition comprising a polylactic acid resin (A) having a D-isomer content of 0 to 2.0 mol % or 98.0 to 100 mol % and tin oxide (B),
wherein the tin oxide (B) is included in an amount of 0.005 to 10 parts by mass in relation to 100 parts by mass of the polylactic acid resin (A).

2. The polylactic acid resin composition according to claim 1, wherein the D-isomer content in the polylactic acid resin (A) is 0 to 0.6 mol % or 99.4 to 100 mol %.

3. The polylactic acid resin composition according to claim 1, further comprising an impact resistance improver (C),
wherein the impact resistance improver (C) is contained in an amount of 0.5 to 15 parts by mass in relation to 100 parts by mass of the polylactic acid resin (A).

4. The polylactic acid resin composition according to claim 1, comprising a thermoplastic resin (M) other than the polylactic acid resin (A),
wherein a mass ratio (A/M) of the polylactic acid resin (A) to the thermoplastic resin (M) is 20/80 to 80/20.

5. A molded body obtained by molding the polylactic acid resin composition according to claim 1.
